(19) United States
(12) Patent Application Publication
(10) Pub. No.: US 2009/0125929 A1
(43) Pub. Date: May 14, 2009

(54) OPTICAL DISC DRIVE DEVICE AND OPTICAL DISC APPARATUS

(75) Inventors: Tomonori Nakada, Saitama (JP); Akira Ohsuga, Saitama (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, TOKYO (JP)

(21) Appl. No.: 12/160,029

(22) PCT Filed: Dec. 27, 2006
(86) PCT No.: PCT/JP2006/326028

§ 371 Date: Nov. 28, 2008

(30) Foreign Application Priority Data
Jan. 5, 2006 (JP) 2006-000702

(51) Int. Cl. G11B 19/20

(52) U.S. Cl. 720/698

(57) ABSTRACT

A sensor 15 for detecting rotation speed of an optical disc is arranged on a sub-frame 5 so as to be positioned in the vicinity of a spindle motor 7. The sensor 15 has been arranged on a main frame 3 in a LightScribe-compatible optical disc apparatus of the conventional art, but is arranged on the sub-frame 5 in the present embodiment. With this arrangement, the sub-frame 5 near the sensor 15 can be increased in size. Specifically, the space occupied by the sensor 15 near the spindle motor 7 in the conventional art can be used as a region for the sub-frame 5, and thus the sub-frame 5 can be increased in size comparing with the conventional art. As a result, the mass of the sub-frame 5 is more increased than in the conventional art, by which the vibration suppression effect can be enhanced.

### TECHNICAL FIELD OF THE INVENTION

The present invention relates to an optical disc drive having a vibration suppression mechanism, and to an optical apparatus.

### BACKGROUND ART

In an optical disc apparatus for reading and/or writing data on optical discs, such as CDs (compact discs) and DVDs (digital versatile discs), optical systems or servo systems provided therein have a limitation in the ability of performing correct tracking control and focusing control under the conditions where, for example, vibrations are externally applied to the apparatus or vibrations are generated by the apparatus per se. In particular, when such an apparatus is used as a storage device for a computer, the vibration generated by the apparatus per se raises a serious problems for high-speed operation, for example during high-speed reading or high-speed seeking, performed by the drive.

To mitigate such a problem, an optical disc apparatus has been suggested (e.g., see Patent Document 1), which includes: a main frame for mounting a spindle motor for rotatably driving an optical disc, and a pickup for reading the optical disc; and a sub-frame to be linked with the main frame through elastic members.

FIG. 1 illustrates a vibration model of an optical disc apparatus 10 having such a main frame 3 and a sub-frame 5. The main frame 3 is elastically supported on a housing 1 through first elastic members 2, and thus can maintain a structure which is unlikely to be influenced by the external vibration, owing to the operation of the first elastic members 2. At the same timer the vibration of the main frame 3 caused by the imbalance or the like of an optical disc, is adapted to be suppressed by a dynamic vibration absorption mechanism which is configured by second elastic members 4 and the sub-frame 5. It is known that the larger the mass of the sub-frame 5 is, the more effectively the dynamic vibration absorption mechanism functions.

Patent Document 1. Japanese Patent Laid-Open No. 11-328944

### DISCLOSURE OF THE INVENTION

### Problems to be Solved by the Invention

However, in the art of an optical disc apparatus having a trend of reducing size, thickness and weight, it may sometimes be difficult to obtain a spatially satisfactory shape of the sub-framer and to concurrent satisfy the standard, and thus the mass of the sub-frame may not be increased.

For example, in the case where a component, such as a sensor, being part of an optical disc apparatus is provided on the main frame, that component having a predetermined thickness may be unavoidably brought into contact with the sub-frame. Therefore, portions of the sub-frame, which would be in contact with the component, are cut off to fit. For this reason, the mass of the sub-frame having the resultant shape will be reduced by an amount corresponding to the amount of cut off, while at the same time the shape of the sub-frame will be unbalanced, that is, the sub-frame will have a problem of being off-balanced front and back as well as right and left.

The present invention has been made in light of the circumstances provided above, and has an object, for example, of providing an optical disc drive with a sub-frame having a large mass for more effectively suppressing vibration, and to provide an optical disc apparatus provided with an optical disc drive.

### Means for Solving the Problems

In order to achieve the object provided above, an optical disc drive recited in claim 1 comprising: a first frame which mounts a spindle motor for rotatably driving an optical disc, and a pickup for reading the optical disc; and a second frame which is linked with the first frame through an elastic member, is characterized in that a given component is arranged on the second frame.

An optical disc apparatus recited in claim 7 is characterized in that the apparatus comprises. the optical disc drive set forth in any one of claims 1 to 6; and a housing for supporting the first frame through an elastic member.

### BRIEF DESCRIPTION OF THE DRAWINGS

FIG. 1 illustrates a vibration model of a conventional optical disc apparatus;

FIG. 2 is a plan view illustrating an optical disc drive related to an embodiment of the present invention;

FIG. 3 is a cross-sectional view illustrating an optical disc drive related to an embodiment of the present invention;

FIG. 4 is a plan view illustrating a conventional optical disc drive;

FIG. 5 illustrates an installation position of an optical disc drive related to an embodiment of the present invention, and an installation position of a sensor of a conventional optical disc drive;

FIG. 6 illustrates the shapes of a sub-frame of an optical disc drive related to an embodiment of the present invention, and a sub-frame of a conventional optical disc drive;

FIG. 7 illustrates the vibration characteristics of an optical disc drive according to an embodiment of the present invention and a conventional optical disc drive;

FIG. 8 illustrates an example of the results of a simulation indicating displacements of a sensor caused by vibration in the case where the sensor is arranged on a sub-frame;

FIG. 9 illustrates influences caused on a slit interval by the vibration of the sub-frame in the results of the simulation illustrated in FIG. 8;

FIG. 10 illustrates an example of a method for attaching a sensor to a sub-frame in an optical disc drive related to an embodiment of the present invention;

FIG. 11 illustrates an example of an arrangement of a sensor of an optical disc drive related to another embodiment of the present invention; and

FIG. 12 illustrates examples of arrangements of sensors of optical disc drives related to still another embodiment of the present invention.

### DESCRIPTION OF SYMBOLS

1 Main frame
2 First elastic members
3 Sub-frame
4 Second elastic members
5 Sub-frame
6 Turntable
7 Spindle motor
8a, 8b Guide rails
9 Pickup
10 Optical disc apparatus
11 Drive screw
12 Stepping motor
15 Rotation-speed detecting sensor
16a, 16b Sensors for determining disc shapes
17a Inner periphery detecting sensor
17b Outer periphery detecting sensor
10, 100, 200, 300a, 300b Optical disc drives

### BEST MODES FOR CARRYING OUT THE INVENTION

With reference to the drawings, hereinafter will be described some embodiments of the present invention. The embodiments described below are based on the case where the present invention is applied to a LightScribe-compatible optical disc apparatus. The LightScribe-compatible optical disc apparatus refers to an optical disc apparatus which enables writing of characters and images on the surface of the label of a CD or DVD, using the laser beam of an optical drive.

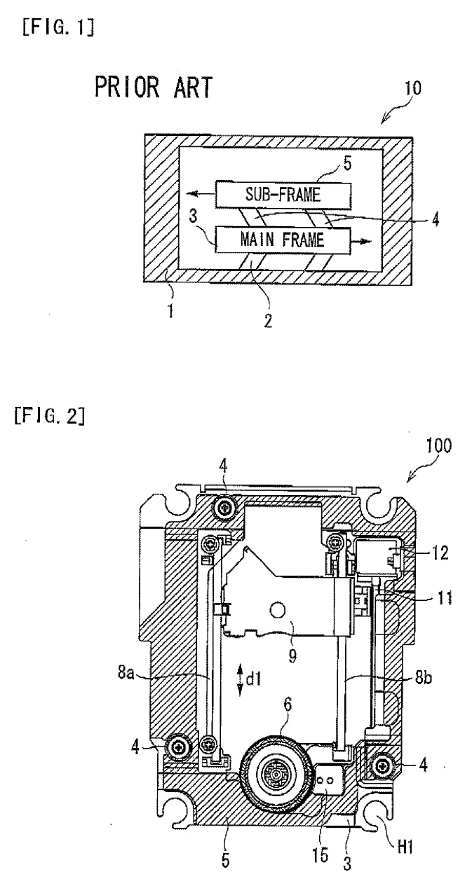

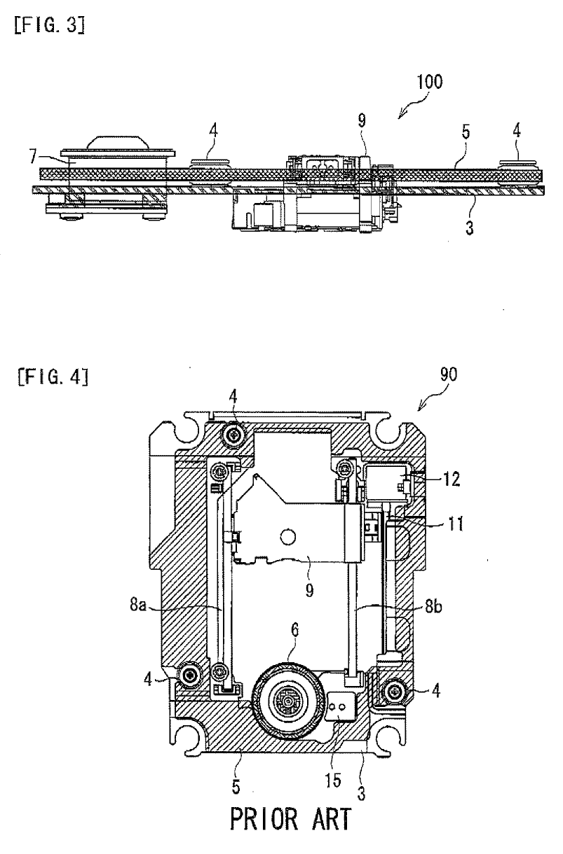

FIG. 2 is a plan view of an optical disc drive 100 related to an embodiment of the present invention. FIG. 3 is a cross-sectional view of the optical disc drive 10. The optical disc drive 100 is a part of an optical disc apparatus, which is directly related to writing/reading of data on an optical disc. In particular, the optical disc drive 100 refers to a mechanism structured by a main frame 3, a sub-frame 4 and second elastic members 4 shown in FIG. 1, excluding a housing 1 and first elastic members 2.

As shown in FIGS. 2 and 3, a spindle motor 7 having a turntable 6 for rotating an optical disc is attached to the main frame 3. The main frame 3 is provided with guide rails 8a and 8b which are arranged so as to be parallel to each other. A pickup 9 is engaged with the guide rails 8a and 8b so as to be movable along the guide rails 8a and 8b. The pickup 9 is engaged with a drive screw 11 and moves along the radial direction (direction indicated by reference d1 in FIG. 2) of the optical disc so that the pickup 9 can be guided to a predetermined track. One end of the drive screw 11 is engaged with a stepping motor 12.

Thus, it is so configured that, upon rotatably driving the stepping motor 12, the drive screw 11 is rotated, so that the pickup 9 can move in the radial direction of the optical disc. The direction of movement of the pickup 9 is determined by the direction of rotation of the stepping motor 12.

The pickup 9 is an optical pickup consisting, for example, of a laser light source and a lens, that is, an optical system, and includes an actuator having a drive coil for driving an objective lens, not shown, to perform focusing control, tracking control, and the like.

The sub-frame 5 serving as a dynamic vibration absorption mechanism is attached to the main frame 3 through the second elastic members 4. From the viewpoint of the mass of the sub-frame 5, the sub-frame 5 is preferably made of metal. Also, from the viewpoint of damping effect, the second elastic members 4 are preferably made of rubber, resin or the like, in particular. The engagement between the second elastic members 4 and the sub-frame 5 may be made with such methods as mechanical engagement using screws or the like, as well as fitting using the an elastic resin, and adhesion using an adhesive, Mounting holes H1 are formed at four outer edge corners of the main frame 3, by which the main frame 3 can be attached to the housing 1 through the first elastic members 2.

A rotation-speed detecting sensor 15 essential for the LightScribe-compatible optical disc apparatus is provided on the sub-frame 5 so as to be located near the spindle motor 7. The rotation-speed detecting sensor 15 detects the inner peripheral information (slits for detecting rotation speed) of the LightScribe-compatible optical disc. Thus, the sensor 15 is arranged at a position for enabling reading of the inner peripheral information, which position, in particular, may favorably be a position within 21.15 mm of the center of the spindle motor 7. A LightScribe-compatible optical disc apparatus is an optical disc apparatus which enables writing of desired characters and images on the surface of the label of a LightScribe-compatible optical disc. In performing writing, it is necessary to monitor the number of rotations of the optical disc and to control rotation to a constant number of rotations in order to write precise characters and images on the surface of the label. The rotation-speed detecting sensor 15 is a sensor for monitoring the number of rotations.

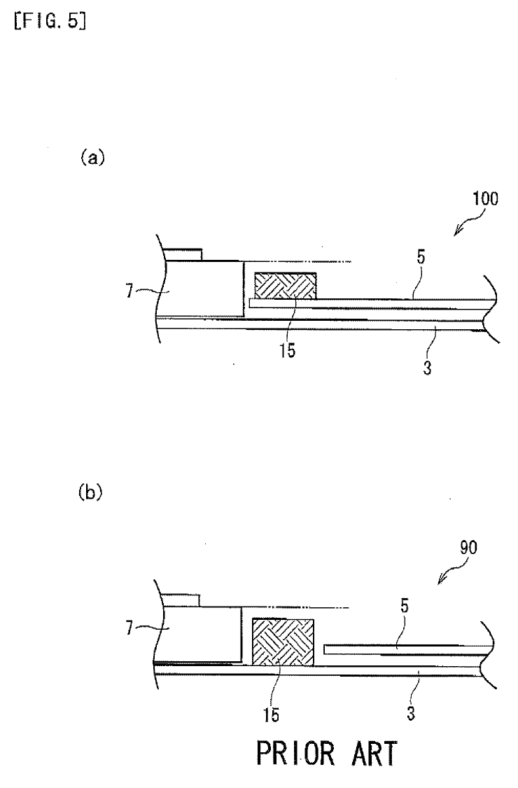

In a conventional LightScribe-compatible optical disc apparatus, the rotation-speed detecting sensor 15 has been provided on the main frame 3 as shown in FIG. 4. In the present embodiment, however, the sensor 15 is arranged on the sub-frame 5 (as shown in FIGS. 2 and 4, the location, in plan, of the rotation-speed detecting sensor 15 of the present embodiment is the same as the conventional location), whereby the sub-frame 5 can be ensured to be increased in size near the rotation-speed detecting sensor 15. Specifically, as shown by (b) of FIG. 5, in the conventional art, the space occupied by the rotation-speed detecting sensor 15 in the vicinity of the spindle motor 7 cannot be occupied by the sub-frame 5. However, as shown by (a) of FIG. 5, in the present embodiment, the space occupied by the rotation-speed detecting sensor 15 in the vicinity of the spindle motor 7 can be used as a region for the sub-frame 5, and thus the sub-frame 5 can be formed larger than in the conventional art. As a result, the mass of the sub-frame 5 can be made larger than in the conventional art to obtain a larger effect in the suppression of vibration. Also, the mass balance of the sub-frame 5, which has been deviated leftward, can be improved by increasing the mass of the sub-frame 5 on the right side to thereby form the sub-frame 5 having good mass balance (see FIGS. 2 and 4).

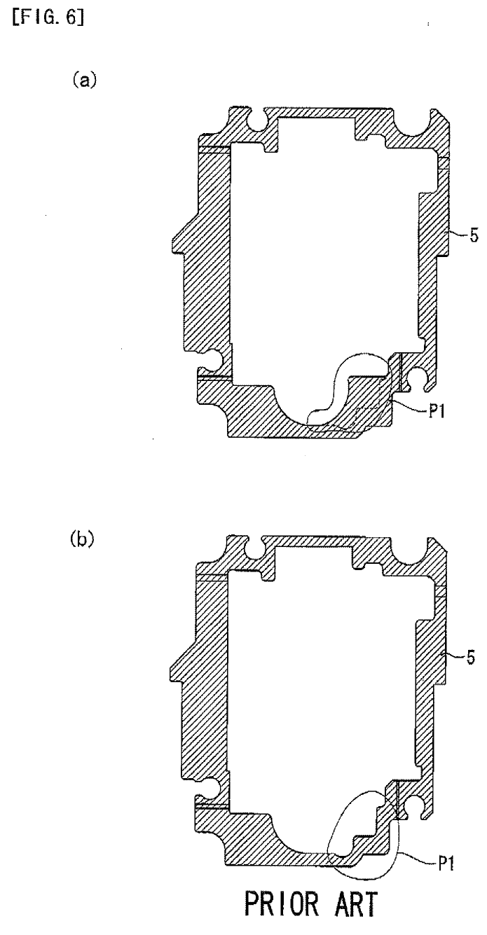

FIG. 6 shows (a) the shape of the sub-frame 5 according to the present embodiment, and (b) the shape of the sub-frame 5 of the conventional art. As shown by (a) and (b) of FIG. 6, the sub-frame 5 in a region PI for arranging the rotation-speed detecting sensor 15 can be made larger than in the conventional art. Thus, in the present embodiment, the sub-frame 5, being given no spatial constraint by the rotation-speed detecting sensor 15, can be increased in size. Specifically, comparing the shapes of the sub-frames 5 shown by (a) and (b) of FIGS. 6, the sub-frame S of the present invention is increased in mass by 10% comparing with that of the conventional art.

Hereinafter, the vibration suppression function of the optical disc drive 100 will be explained. When the optical disc is rotated, vibration is caused in the main frame 3 by the imbalance of the optical disc rotated by the spindle motor 7. The vibration is then transferred to the sub-frame 5 through the main frame 3 and the second elastic members 4. In this case, the vibration depends on the transfer characteristics of the sub-frame 5 and the second elastic members 4. At a frequency which is sufficiently lower than the resonance frequency of both of the vibration systems, the sub-frame 5 is integrally in motion with the main frame 3. On the other hand, at a frequency which is sufficiently higher than the resonance frequency, almost no vibration of the main frame 3 is transferred to the sub-frame 5. At a frequency proximate to the resonance frequency, light damping may emphasize the vibration, while heavy damping may cause no influence of the secondary resonances. The phases of the transferred vibrations are the same at a frequency lower than the resonance frequency, are reversed at a frequency higher than the resonance frequency, and are orthogonal to each other at the resonance frequency. Accordingly, appropriate selection of a resonance frequency and a damping coefficient may allow the sub-frame 5 to exert the vibration suppression effect against vibration frequencies lower than the resonance frequency or near the resonance frequency.

As described above, the first elastic members 2 have a function of maintaining the structure of the main frame 3 so as to be unlikely to have an influence of external vibration. Also, the vibration of the main frame 3 caused by the imbalance or the like of the optical disc can be suppressed by the dynamic vibration absorption function attained by the sub-frame 5 and the second elastic members 4. Further; reading of information from the optical disc by the pickup 9 can be precisely performed during high-speed rotation of the optical disc. In the present embodiment, the sub-frame 5 can be formed larger than in the conventional art, and thus the mass of the sub-frame 5 can be increased. Accordingly, a better effect can be achieved in the vibration suppression during the high-speed rotation of the optical disc.

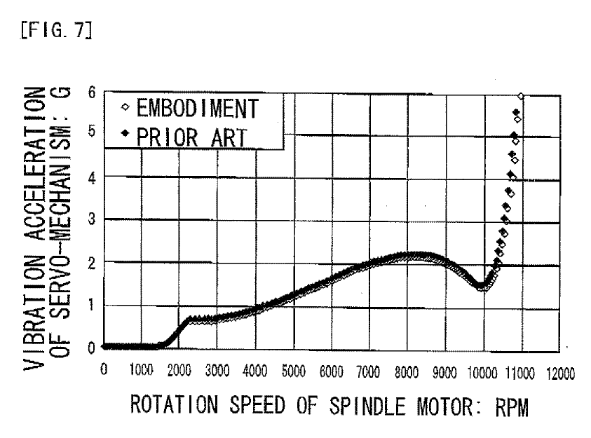

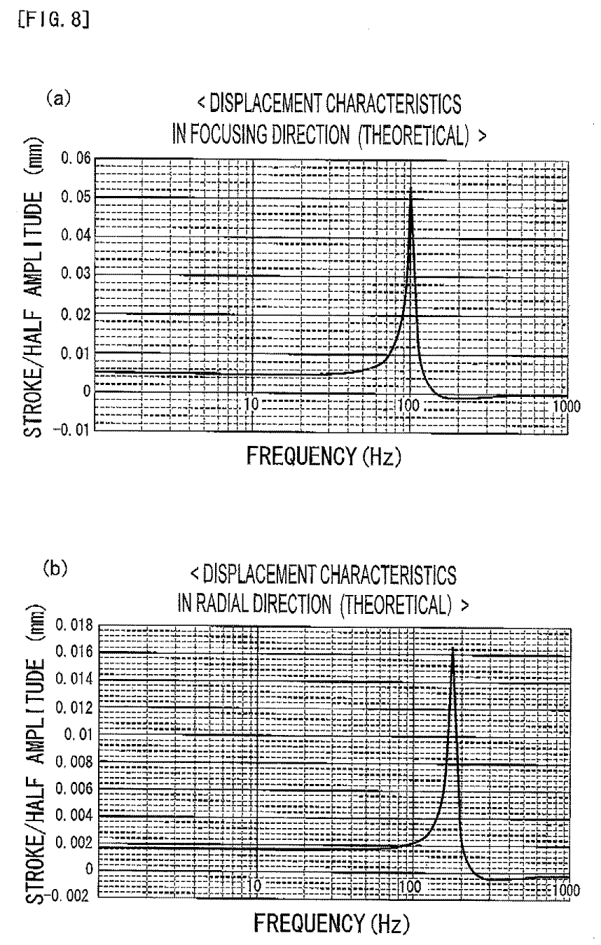

The vibration suppression effect corresponding to the increased mass described above can be quantitatively indicated by simulation. FIG. 7 is a graph illustrating a relationship between the vibration level and the number of rotations of a disc, for each of an optical disc drive 90 of the prior art and the optical disc drive 100 according to the present embodiment having a mass 10% larger than the optical disc drive 90. As shown in FIGS. 7, about 5% improvement can be seen at 8500 rpm exerting the highest vibration level.

Let us consider now the influence on the rotation-speed detecting sensor 15 caused by the case where the rotation-speed detecting sensor 15 is arranged on the sub-frame 5. As described above, the sub-frame 5 serving as a dynamic vibration absorber suppresses the vibration of the main frame 3 in high-speed rotation (at high frequencies). Therefore, the sub-frame 5 per se vibrates in a phase reverse from that of the main frame 3. With the vibration of the sub-frame 5, the rotation-speed detecting sensor 15 arranged on the sub-frame 5 unavoidably vibrates synchronously. However, the rotation-speed detecting sensor 15 is operated only when characters or images are written on the surface of the label of the LightScribe-compatible optical disc. The operation of the sensor 15 in this case corresponds to the operation at low-speed rotation, and thus the vibration caused on the rotation-speed detecting sensor 15 is considered to be small.

FIG. 8 shows this matter in the form of the results of simulation calculation in a quantitative manner. FIG. 8 shows data resulting from the case where, for example, a mass-eccentric disc of 1 g·cm is rotated to perform writing on the surface of the label of a LightScribe-compatible optical disc. Specifically, FIG. 8 shows by (a) the amplitude (displacement) in the focusing direction (the direction perpendicular to the label surface), Assuming that the writing is performed at 2000 rpm (33.3 Hz), the amplitude then will be ±0.006 mm. FIG. 8 shows by (b) the amplitude (displacement) in the radial direction (the direction parallel to the label surface). Similarly, assuming that the writing is performed at 2000 rpm (33.3 Hz), the amplitude then will be ±0.0017 mm.

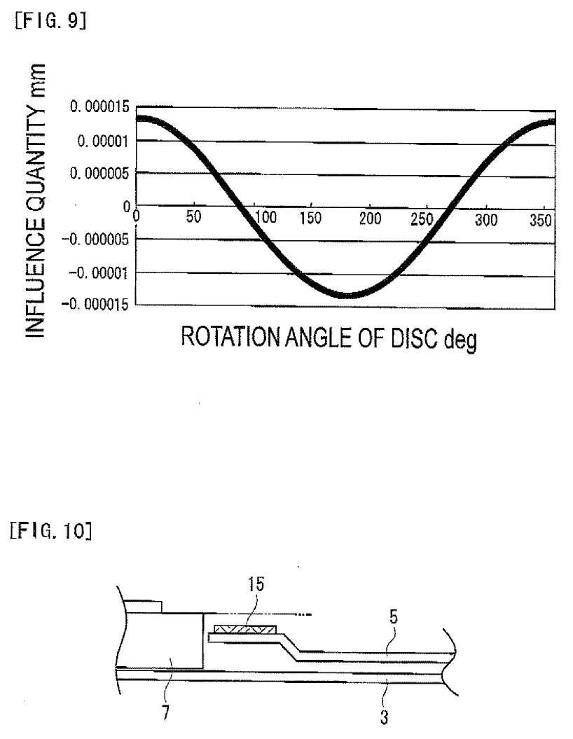

As to the focusing direction, the range in which the rotation-speed detecting sensor 15 can be used is ±0.15 mm (1.55±0.15 mm), and thus the numerical value ±0.006 mm provided above raises no problem in the actual use. As to the radial direction, the influence on rotation-detecting slits (400 slits are arranged along the circumference at a widthwise interval of 0.14922±0.00015 mm), which are provided on the LightScribe-compatible optical disc, can be calculated as shown in FIG. 9. Specifically, since the maximum value 0.000013 mm falls within the error of the width of each rotation-detecting slit, the above numerical value ±0017 mm raises no problem as well in actual use.

In this way, as can be understood from the results of the simulations, the arrangement of the rotation-speed detecting sensor 15 on the sub-frame 5 causes no adverse effect on the rotation-speed detecting sensor 15.

Methods for attaching the rotation-speed detecting sensor 15 described above onto the sub-frame 5 may include, (1) a method for attaching a spacer (resin) as a separate component and fixing the rotation-speed detecting sensor 15 on the spacer; and (2) a method for performing outsert molding of a spacer (resin) and fixing the rotation-speed detecting sensor 15 on the spacer. However, the following method will be excellent from the viewpoints of cost and installation accuracy in the focusing direction of the rotation-speed detecting sensor 15. That is, (3) a method for partially bending up the sub-frame 5 made up of a metal plate, as shown in FIG. 10, and directly fixing the rotation-speed detecting sensor 15 onto the bent up portion. This method, which uses no spacer, can save cost that would be required for spacers. Also, this method allows direct fixation of the rotation-speed detecting sensor 15 onto the sub-frame without interposing a spacer to thereby provide an advantage of excellent installation accuracy.

As described above, according to the optical disc drive 100 of the present embodiment, the rotation-speed detecting sensor 15, which has originally been arranged at the main frame 3, is installed being moved to the sub-frame 5. Thus, the sub-frame 5 can be increased in size with concurrent increase in the mass of the sub-frame 5, whereby the vibration suppression effect can be enhanced. Also, comparing with the conventional art, the balance of the shape of the sub-frame 5 can be improved, by which better balance can be kept in the mass of the subframe 5. In addition, since the mass of the rotation-speed detecting sensor 15 can contribute to the increase in the mass of the sub-frame 5 as a whole, the vibration suppressing effect can be further enhanced.

Various modifications and changes can be made in the embodiment described above within a scope of not departing from the spirit of the present invention. In the embodiment described above, the present invention has been applied to a LightScribe-compatible optical disc apparatus, for example, in which the rotation-speed detecting sensor 15 is arranged on the sub-frame 5. However, the application of the present invention is not limited to the application to the LightScribe-compatible optical disc apparatus. Also, the sensor arranged on the sub-frame is not limited to the rotation-speed detecting sensor 15. For example, the rotation-speed detecting sensor may be arranged on an optical disc apparatus which is not the LightScribe-compatible optical disc apparatus. In this case, the rotation-speed detecting sensor may preferably be arranged within about 22 mm from the center of the spindle motor 7 (inside a data region of an optical disc) (provided that the optical disc is directly monitored for detection of the rotation speed).

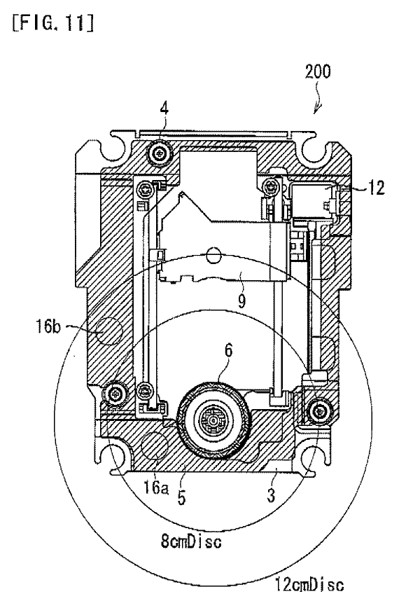

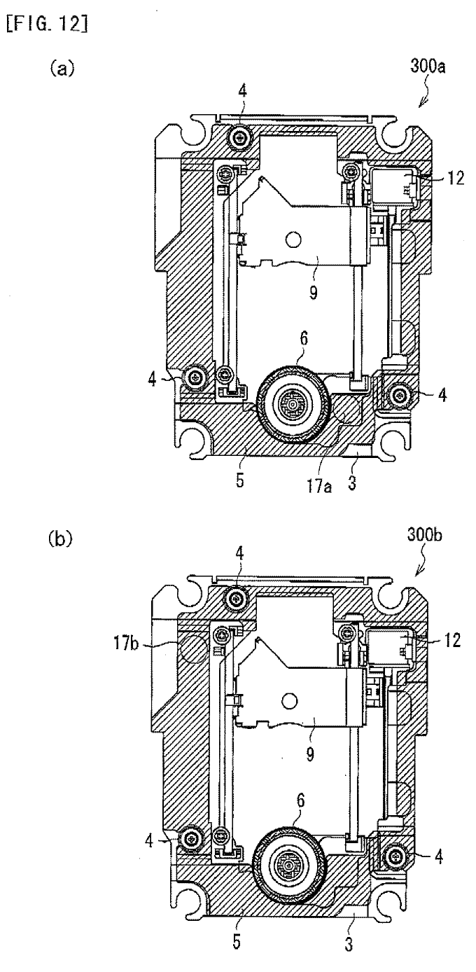

FIG. 11 illustrates an example of an arrangement in which the present invention is applied to an optical disc apparatus other than the LightScribe-compatible optical disc apparatus, and a sensor 16 for determining the shape of a disc is disposed on the sub-frame 5. As shown in FIG. 11, two sensors 16a and 16b are arranged on the sub-frame 5 within 8 cm and within the range of 8 to 12 cm, respectively, from the center of the spindle motor 7. As a result, it is ensured that a determination can be made as to whether the optical disc in question is an 8-cm optical disc or a 12-cm optical disc, based on a combination of signals detected by the two sensors 16a and 16b. In this way, the sensor 16 for determining the shape of a disc can be arranged on the sub-frame 5 rather than on the main frame 3 as has been done in the conventional art, whereby the sub-frame 5 can be increased in size comparing with the conventional art. Thus, the mass of the sub-frame 5 can be increased to thereby further enhance the vibration suppression effect. Although two sensors have been arranged in the example shown in FIG. 11, three or more sensors may be arranged as a matter of course. In this case, the more the number of the sensors is increased, the more the mass of the sub-frame 5 as a whole is increased, and thus the vibration suppression effect can be enhanced. The arrangement positions of the sensors are not limited to the ones indicated in FIG. 11, but may by anywhere if the above conditions (within 8 cm and within the range of 8 to 12 cm from the center of the spindle motor 7) are met. For example, the sensors may all be arranged in alignment along a lower frame of the sub-frame 5 (the side near the spindle motor 7). This arrangement has an advantage that, in inserting an optical disc, the shape of the optical disc can be determined at an earlier stage. Alternatively, instead of arrange all of the sensors on the sub-frame 5, some may be arranged on the main frame 3 (e.g., one may be arranged on the main frame 3 and two may be arranged on the sub-frame).

FIG. 12 illustrates, by (a) and by (b) i examples in which the present invention is applied to an optical disc apparatus other than the LightScribe-compatible optical disc apparatus. In particular, in these examples, the present invention is applied to a sensor 17 for detecting the position of the pickup 9. FIG. 12 shows by (a) an example of arranging an inner periphery detecting sensor 17a for detecting the fact that the pickup 9 has been positioned at the inner periphery of the optical disc. FIG. 12 shows by (b) an example of arranging an outer periphery detecting sensor 17b for detecting the fact that the pickup 9 has been positioned at the outer periphery of the optical disc. In these cases, the inner and outer periphery detecting sensors 17a and 17b may be contact or non-contact sensors. In this way, the sensor 17 for detecting the position of the pickup 9 can be arranged on the sub-frame 5 rather than on the may frame 3 as have been done in the conventional art, whereby the sub-frame 5 can be increased in size comparing with the conventional art. Thus, the mass of the sub-frame 5 can be increased to thereby further enhance the vibration suppression effect.

In the case of the sensor 16 for determining the shape of a disc and the sensor 17 for detecting the position of the pickup 9 mentioned above, the arrangement position on the main frame 3 and that on the sub-frame 5 (the positional relationship, in plan, shown in FIGS. 2 and 4) may not necessarily be the same. If only the sensors 16 and 17 can realize the same functions the arrangement positions are not intended to be limited to those described above.

In addition, the components to be arranged on the sub-frame 5 are not limited to the sensors as described above, but those components which are originally arranged on the main frame 3 or other components may be arranged on the sub-frame 5. For example, a disc lead-in arm for a slot-in type drive may be arranged on the sub-frame 5 to increase the entire mass of the sub-frame 5, so that the vibration suppression effect can be enhanced.

In the embodiment described above, a given component has been arranged on the sub-frame 5. In addition to this component, another weight may be arranged on the sub-frame 5 to realize a desirable mass balance. Thus, the entire mass of the sub-frame 5 can be increased, so that the vibration suppression effect can be further enhanced.

Thus, the optical disc drive apparatus of each embodiment described above includes: the main frame 3 for mounting the spindle motor 7 for rotatably driving an optical disc, and the pickup 9 for reading the optical disc; and the sub-frame 5 linked with the main frame 3 through the elastic members 4. In the apparatus, a given component is arranged on the sub-frame 5 to increase the mass of the sub-frame 5 as a whole, whereby the vibration suppression effect can be more excellently exerted.

1. An optical disc drive comprising:
a first frame which mounts a spindle motor for rotatably driving an optical disc, and a pickup for reading the optical disc; and
a second frame which is linked with the first frame through an elastic member,
characterized in that a given component is arranged on the second frame.

2. The optical disc drive according to claim 1, wherein the component arranged on the first frame is moved so as to be arranged on the second frame.

3. The optical disc drive according to claim 2, wherein a region is expanded, which region has previously been occupied by the component when the component was arranged on the first frame, so that the second frame can be formed with a large frame shape.

4. The optical disc drive according to claim 3, wherein the component is arranged on the expanded region in the second frame.

5. The optical disc drive according to claim 4, wherein the component is a sensor for detecting revolution speed of the optical disc.

6. The optical disc drive according to claim 5, wherein the sensor is arranged within about 22 mm from a center of the spindle motor.

7. An optical disc apparatus wherein the apparatus comprises:
an optical disc drive comprising,
a first frame which mounts a spindle motor for rotatably driving an optical disc, and a pickup for reading the optical disc, and
a second frame which is linked with the first frame through an elastic member, wherein a given component is arranged on the second frame; and
a housing for supporting the first frame through an elastic member.

8. The optical disc apparatus according to claim 7, wherein the component arranged on the first frame is moved so as to be arranged on the second frame.

9. The optical disc apparatus according to claim 8, wherein a region is expanded, which region has previously been occupied by the component when the component was arranged on the first frame, so that the second frame can be formed with a large frame shape.

10. The optical disc apparatus according to claim 9, wherein the component is arranged on the expanded region in the second frame.

11. The optical disc apparatus according to claim 10, wherein the component is a sensor for detecting revolution speed of the optical disc.

12. The optical disc apparatus according to claim 11, wherein the sensor is arranged within about 22 mm from a center of the spindle motor.
